(19) United States
(12) Patent Application Publication
(10) Pub. No.: US 2015/0346960 A1
(43) Pub. Date: Dec. 3, 2015

(54) METHOD AND APPARATUS FOR PROVIDING A RUNNING SUM TOTAL OF USER-SELECTED DATA

(71) Applicant: Google Technology Holdings LLC, Mountain View, CA (US)

(72) Inventor: Wen-Ting Yang, Beijing (CN)

(21) Appl. No.: 14/649,901

(22) PCT Filed: Dec. 6, 2012
(86) PCT No.: PCT/CN2012/086078

§ 371 Date: Jun. 4, 2015

(51) Int. Cl. G06F 3/0484; G06F 3/0481

(52) U.S. Cl. CPC G06F 3/04842; G06F 3/0481

(57) ABSTRACT

A method and apparatus provides a running sum total of user-selected data, performed in an electronic device having a display screen. The method includes displaying data from a first application on the display screen, wherein the data includes numeric values; displaying an indication of a datasum application, on the display screen, for user selection; receiving at least one numeric value selected by a user from the data as input to the datasum application; and displaying a running sum total of the input to the datasum application on the display screen.

### FIELD OF THE DISCLOSURE

The present disclosure relates generally to features for electronic devices and more particularly to a method and apparatus for providing and presenting a running sum total of user-selected data.

### BACKGROUND

Conventional electronic devices present data to a user via different data presentation applications such as email, text messaging, word processing, etc. Some data presentation applications are included with the purchase of the device. Additionally, a user can purchase and download other data presentation applications to the device. The different data presentation applications provide a user the ability to view data on the user's device in a particular format that is specific to the particular data presentation application.

Generally, data presentation applications predefine what functionality is available to the user. In addition, current electronic devices and their data presentation applications do not provide flexibility to a user so that the user can process the presented data in a way that was not predefined by the data presentation application. Moreover, current electronic devices and their data presentation applications do not provide for an efficient method of processing data, that the user finds interesting, in a way that was not predefined by the data presentation application. For example, current electronic devices and their data presentation applications do not provide a means for a user to simply and conveniently manipulate (e.g., by performing mathematical operations on) presented data that the user considers interesting.

Accordingly, there is a need for a method and apparatus for providing a running sum total of user-selected data.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an electronic device including a running sum total application in accordance with some embodiments.

FIG. 2 is a flowchart of a method of providing a running sum total of user-selected data in accordance with some embodiments.

FIG. 3 is a schematic of a visual interface in accordance with some embodiments.

FIG. 4 is another flowchart of a method of providing a running sum total of user-selected data in accordance with some embodiments.

FIG. 5 is another schematic of a visual interface in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the disclosure herein.

The apparatus and method components have been represented where appropriate by conventional symbols in the drawings, showing only those specific details that are pertinent to understanding the embodiments of the disclosure herein so as not to obscure the disclosure with details that will be readily apparent to those of ordinary skill in the art having the benefit of the description herein.

### DETAILED DESCRIPTION

Generally speaking, pursuant to the various embodiments, an electronic device presents data to a user for selection. The user is provided with a running sum total feature of the user-selected data.

In one example embodiment, a method performed in an electronic device having a display screen provides for a running sum total of user-selected data. The method includes: displaying data from a first application on the display screen, wherein the data includes numeric values; displaying an indication of a datasum application, on the display screen, for user selection; receiving at least one numeric value selected by a user from the data as input to the datasum application; and displaying a running sum total of the input to the datasum application on the display screen.

In another embodiment, an electronic device provides for a running sum total of user-selected data. The electronic device includes: a processor; memory coupled to the processor, wherein the memory is configured to store a first application and a datasum application; a visual interface coupled to the processor, wherein the visual interface is configured to display data from the first application, wherein the data includes numeric values; a user input device coupled to the processor, wherein the user input device is configured to receive at least one input numeric value selected by a user from the data and to provide the at least one selected numeric value as input to the datasum application; wherein the processor is configured to provide a running sum total, of the input to the datasum application, to the visual interface for presentation to a user.

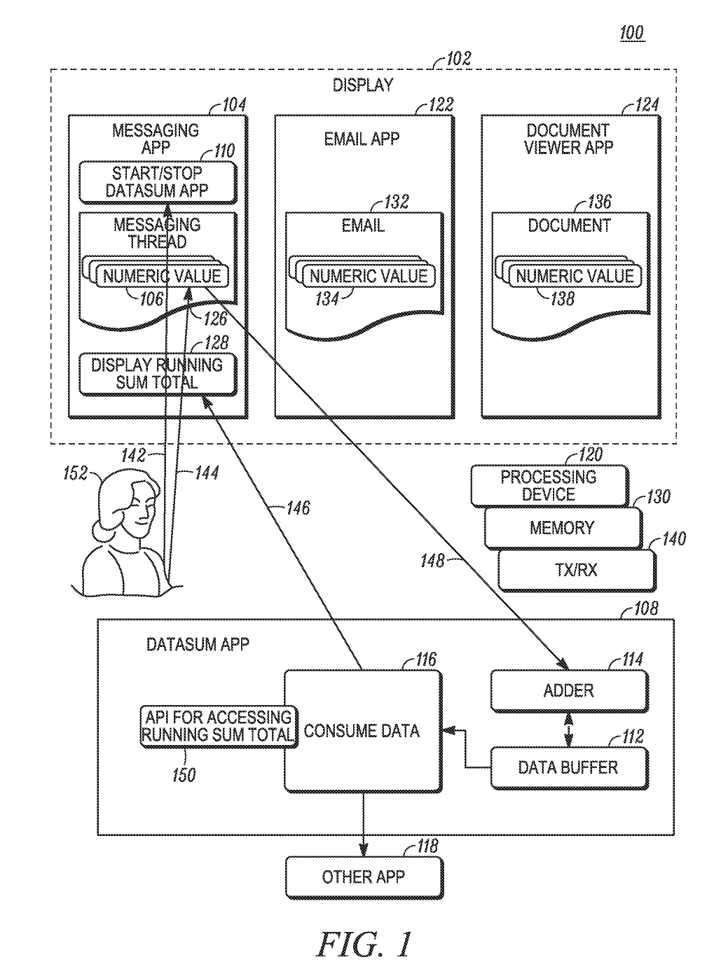

Referring now to the drawings, and in particular FIG. 1, an electronic device including one or more data presentation applications and further including a running sum total application in accordance with some embodiments is shown and indicated generally at 100. More particularly, the electronic device 100 includes a processing device 120 (e.g., processor), a memory 130, a transceiver 140, and a visual interface and user input (which in this case is a touch screen display) 102 operatively coupled and configured to perform methods in accordance with the teachings herein. The processing device 120 comprises hardware that is configured to execute instructions of software (e.g., one or more applications such as a datasum application 108) or firmware stored in the memory hardware 130. The memory 130 represents one or more physical short-term and/or long-term storage elements configured to store various information needed for the functioning of the electronic device 100 including the applications or firmware for programming the processing device 120 with the logic or code needed to perform its functionality.

In an embodiment, the electronic device 100 includes one or more additional components found in a portable wireless communication device but not shown, including, but not limited to: additional Input/Output (I/O) devices (e.g., a keyboard, speakers, microphones, etc.), a GPS circuit/module, etc., that operate together and are configured to provide a user with electronic device functionality.

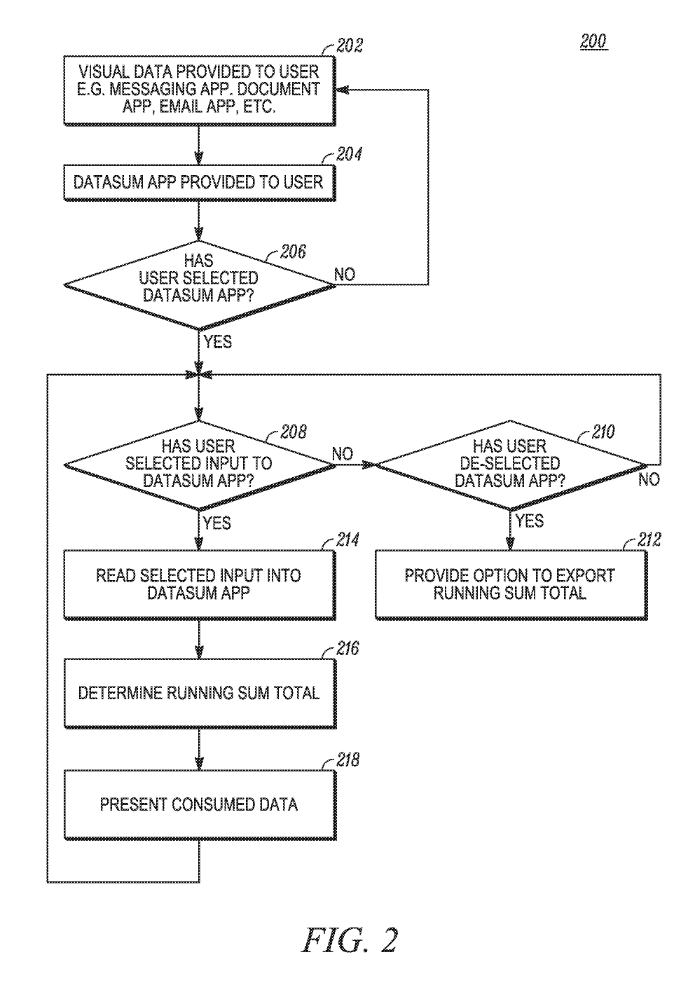

As used herein, elements or components being “adapted to,” “operative to,” “arranged to,” or “configured to” means that such elements or components are implemented using hardware (such as processing devices and memory) and in some embodiments software or firmware (such as when the processing device executes software (e.g., application) or firmware instructions). Moreover, these elements or components when operatively coupled form the means for implementing functionality in accordance with the teachings herein, for instance as illustrated by the methods described by reference to FIGS. 2-5.

In an embodiment, the electronic device 100 is a portable wireless communication device such as a cellular telephone, a smartphone, a personal data assistant (PDA), etc. Those skilled in the art, however, will recognize and appreciate that the specifics of this example are merely illustrative of some embodiments and that the teachings set forth herein are applicable in a variety of alternative settings. For example, since the teachings described do not depend on the electronic device or data presentation applications, they can be applied to any type of electronic device having different types of data presentation applications stored thereon. As such, other alternative implementations of using different types of electronic devices including desktop and laptop computers and data presentation applications that can recognize data as a standalone object that can be exported to a different application are contemplated and are within the scope of the various teachings described.

Turning back to the description of the elements shown in FIG. 1, the electronic device 100 further has stored therein (e.g., in the memory 130) at least one (in this case three) data presentation applications 104, 122, and 124, a running sum total application (also referred to herein as a datasum application) 108, and optionally at least one other application 118 such as an application that presents numeric values in a spreadsheet format. Each data presentation application 104, 122, and 124 comprises software having code or logic instructions that when executed by the processing device 120 visually provides data to a user via (i.e., using) a visual interface such as the touch screen display 102. In the embodiment shown in FIG. 1, the data presentation applications include a short messaging application (e.g., 104), an email application (e.g., 122), and a document viewer application (e.g., 124), etc., wherein the document viewer application is, for example, a word processing application or application used (by the processing device 120) to present documents to the user via the display 102 in a particular predefined format. It should be noted that any combination of the applications 104, 122, or 124 could be stored in the electronic device 100. Moreover, one or more additional or alternative data presentation applications (not shown) could be stored in the electronic device 100.

Returning now to the description of the data presentation applications 104, 122, and 124. In an embodiment, the messaging application 104 (as executed by the processing device 120) presents on the display 102 at least one (i.e., one or more) messaging thread 126 comprising data that includes at least one numeric value 106. As used herein, a “messaging thread” is a set or sequence (i.e., chain) of one or more messages from or associated with the same (i.e., a single) originating entity, which can be a person or a business. In one illustrative implementation, the messaging thread is from the same short messaging number, such as a telephone or portable phone number.

“Data” means alphanumeric text or characters, which may be a sequence or combination of words and numeric values. A “numeric value” is a set or sequence of one or more characters that represents a number or numerical value. In an embodiment, a numeric value includes at least one numeral and may also include a non-numeric character, such as a comma, a decimal, or a character that represents money. With regards to monetary values, the numeric value can take any of the example formats, in this example representing 200 dollars: $200, 200, 200US, two hundred, etc. Also included within the term numeric value is foreign currency values, stock values, etc.

The email application 122 (as executed by the processing device 120) presents on the display 102 at least one email 132 comprising data that includes at least one numeric value 134. The document viewer application 124 (as executed by the processing device 120) presents on the display 102 at least one document 136 comprising data that includes at least one numeric value 138. The datasum application 108, as executed, implements an adder module 114, a consume data module 116, and a data buffer 112. In an embodiment, the data buffer 112 and/or the consume data module 116 is implemented using a region of the physical memory 130.

In accordance with the present teachings, the processing device 120 uses (i.e., executes, implements or carries out) the datasum application 108 in conjunction with a data presentation application (referred to herein as a “first” application) to provide a running sum total of user-selected data, wherein the data is presented to the user on a visual display by the first application. A “running sum total” is the operation of adding a sequence of numeric values. The sequence of numeric values begins with a first or initial numeric value selected by the user after initiating or starting or selecting the datasum application 108. The sequence of numbers ends with a final or last numeric value selected by the user before ending or stopping or de-selecting the datasum application 108.

In one example implementation, the processing device 120 executes the datasum application 108 with the messaging application 104 (which consequently is the “first” application for this use case scenario). While the messaging application 104 is running, a user 152 selects (i.e., initiates, activates, starts) (142) the datasum application 108 using a button or icon or other visual indication 110 of the presence of the datasum application 108 provided to the user via the display 102. This selection signals to the datasum application 108 (e.g., via an application programming interface, which is an interface between two applications in this case) to begin calculating and maintaining the running sum total. In an embodiment, the visual indication 110 is presented via the first application 104 and displayed on the display 102 as if it is a feature of the first application 104. A user “selecting” a visual indication on the display 102, such as selecting the visual indication 110 or selecting data or some other visual or virtual icon, image, shape, or button, is performed using any one or more of a number of actions. These actions include, but are not limited to, the user: pressing (i.e., “clicking”) a virtual button or icon, which means placing a finger on or holding the finger on the icon for a predefined amount of time and/or amount of pressure; swiping (i.e., moving the finger a linear distance) across a virtual bar on the display 102; etc.

The display of the indication 110 can be automatic (for instance upon starting the messaging application 104) or in response to user input (such as the user's selection of a first numeric value 106 for the messaging thread 126. Moreover, the display of the indication 110 can be positioned or located anywhere on the display screen including near (i.e., in the vicinity of or in proximity to) a numeric value selected by the user 152 or a running sum total 128 displayed to the user. “Near,” in one embodiment, means less than one inch (i.e., about 25.4 mm) and in another embodiment is less than one half inch (i.e., about 12.7 mm) and in yet another embodiment is less than one quarter inch (i.e., about 6.35 mm).

Each time the user selects (144) a numeric value 106 from the data displayed by the first application 104, the datasum application 108 receives (148) the numeric value as input, for instance using a first application programming interface (API) contained in the first application 104, and calculates (using the adder 114) a running sum total of the collective user-selected numeric value inputs. More particularly, the adder module 114 performs a summation operation (i.e., the operation of adding) of a sequence of numeric values to create the running sum total. Put another way, the adder module 114 maintains a cumulative current or present total value of all numeric value inputs, and adds the current total to a next user-selected numeric value to provide the updated running sum total. If needed, the adder module 114 also converts each numeric value input into a predefined format that is compatible with the summation operation.

The adder 114 provides the running sum total to the data buffer 112. The data buffer 112 temporarily holds the running sum total while it is being moved to the consume data module 116. The consume data module 116 maintains the running sum total and exports the running sum total external to the datasum application 108, for example using an application programming interface 150 within the datasum application 108. For example, the consume data module 116, maintains the running sum total until the datasum application is reset or de-selected. In one embodiment, the consume data module 116 automatically exports (146) the running sum total as an object to the first application for presentation (e.g., 128) using the display 102. In one illustrative implementation, the exporting is performed using the API 150 and a second API (not shown) in the first application 104. In another embodiment, the consume data module 116 exports the running sum total as an object to a different application 118 such as a spreadsheet application for inclusion in additional mathematical operations or for presentation using the display 102.

As mentioned above, the consume data module 116 maintains the current or updated running sum total until the datasum application 108 is reset or de-selected. De-selecting indicates to the datasum application 108 to stop calculating and maintaining the running sum total. In such a case, the datasum application 108 zeroes out (or otherwise erases or eliminates) values associated with the current running sum total in the adder 114, the data buffer 112, and the consume data module 116. In one embodiment, the user selects the indication 110 to de-select the datasum application 108. For example, the user presses or swipes the indication 110. In a further embodiment, upon receiving an indication of the de-selecting, the datasum application 108 prompts the user 152 (via the messaging application 104 for instance) for further action. This prompting, in one embodiment, includes a visual indication (not shown) for performing further actions such as exporting the final running sum total to a different application such as the email application 122, the document viewer application 124 or another application 118 or into memory 130 to use at another time.

In accordance with an embodiment of the present teachings, for instance as described with respect to the remaining figures, an electronic device 100 for providing a running sum total of user-selected data includes: a processing device 120 (e.g., processor), a memory 130 coupled to the processor. The memory 130 is configured to store a first application, such as a messaging application 104, and a datasum application 108. The device 100 includes a visual interface, such as a display 102, coupled to the processor. The visual interface is configured to display data from the first application (e.g., messaging application 104), wherein the data includes numeric values 106. The device 100 includes a user input device coupled to the processor. The user input device is configured to receive as an input at least one numeric value 106 selected by a user 152 from the data and to provide the at least one selected numeric value 106 as input to the datasum application 108. The processor is configured to provide a running sum total, of the input to the datasum application 108, to the visual interface (e.g., display 102) for presentation to the user 152.

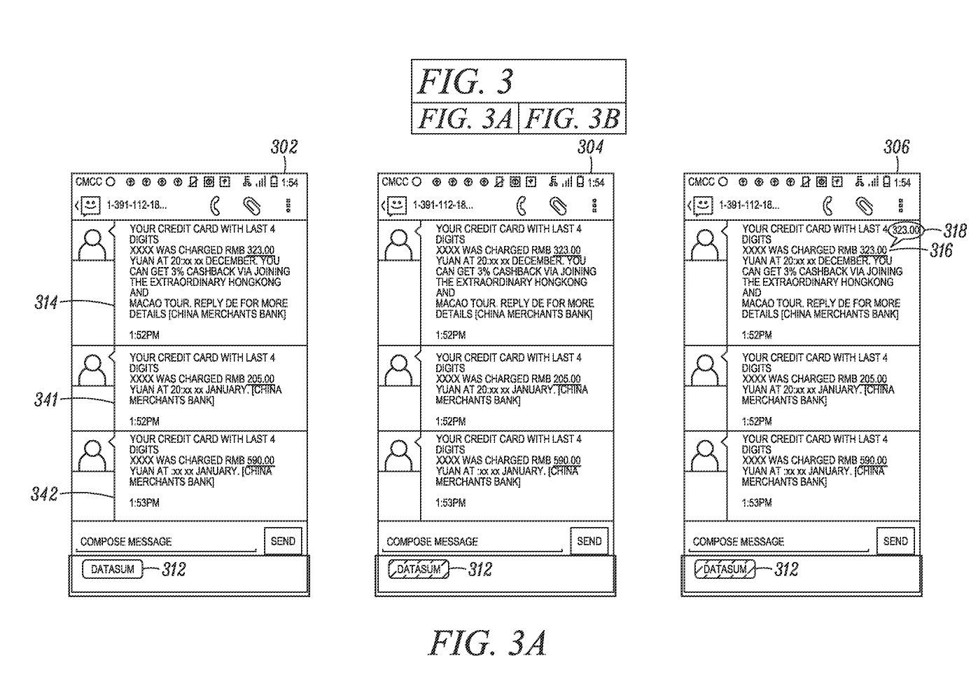

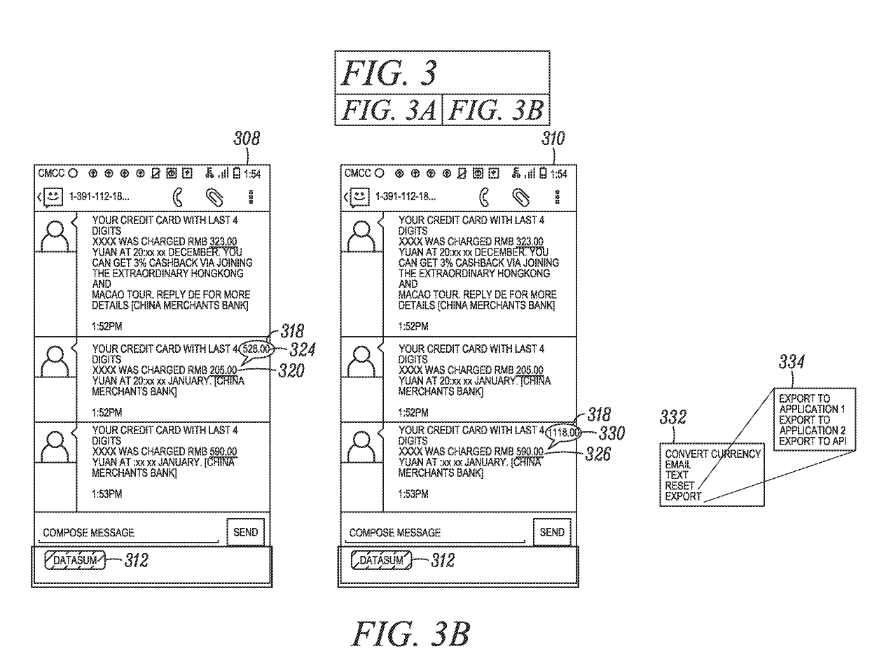

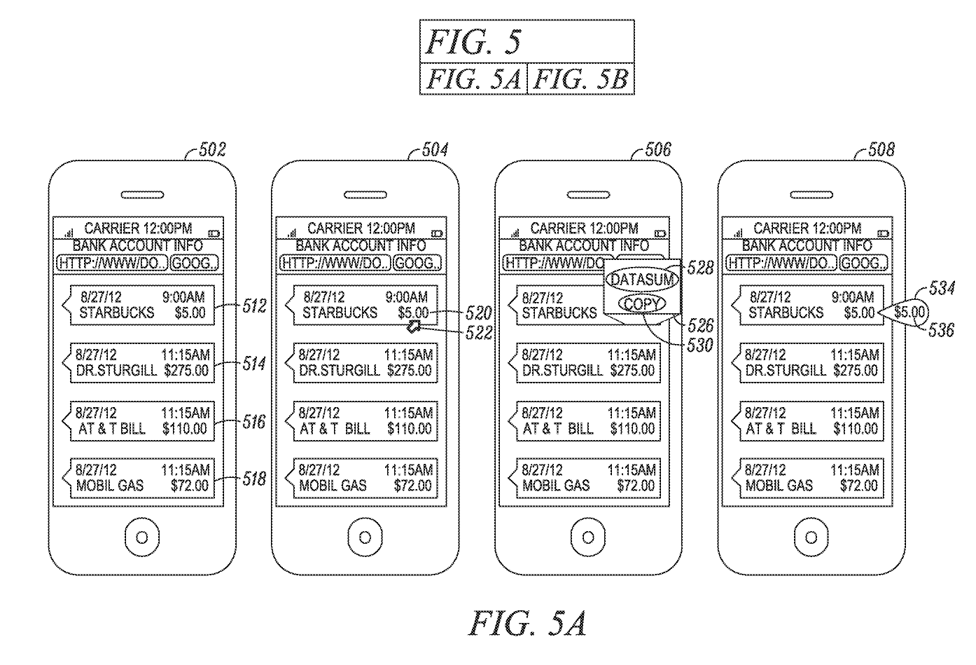

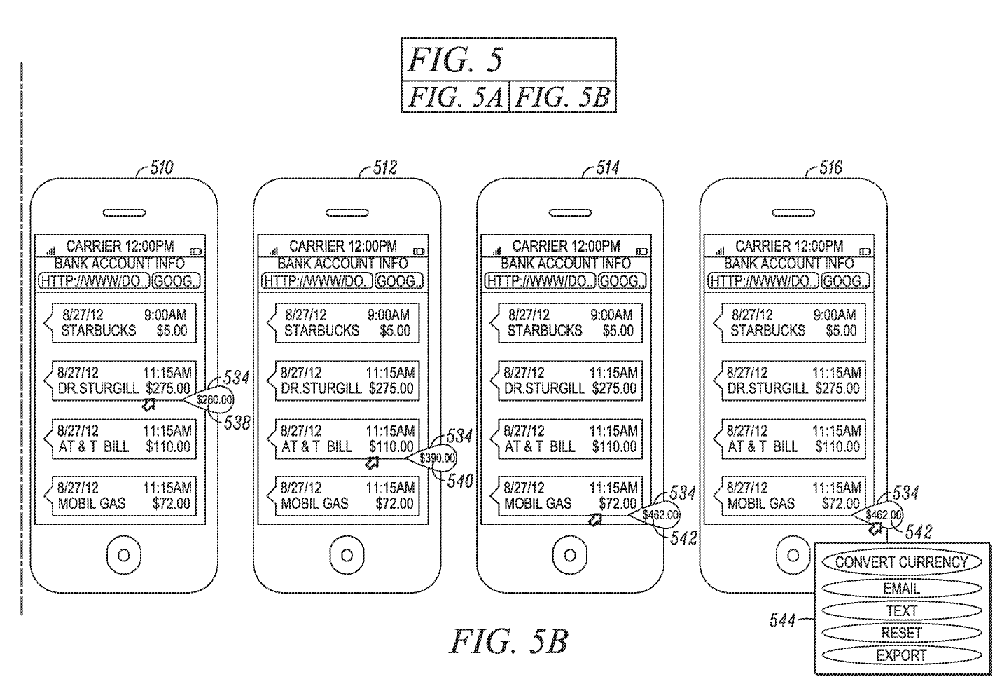

The following lists some example embodiments that are covered by the disclosure. The visual interface and the user input of the electronic device 100 comprise a touch screen display. The electronic device 100 is a portable wireless communication device. The datasum application 108 includes a consume data module 116 configured to export the running sum total to at least one of the first application (e.g., 104, 122, 124), a second application (e.g., 118), or an application programming interface (e.g., 150). The processor and the visual interface are configured to display an indication (e.g., 110) of the datasum application for user selection to initiate calculation of the running sum total. For example, the indication may be provided on the display screen 102 by presenting a datasum application icon (e.g., 528 of FIG. 5) in response to the user selecting a first numeric value from the data. The indication of the datasum application is located on the display screen 102 near the first selected numeric value. The processor and the visual interface are configured to present the running sum total in a hovering bubble (e.g., 318 of FIG. 3) configured as a geometric shape that encloses the running sum total. The processor is configured to process a set of one or more clicks on the hovering bubble (e.g., 318) by the user as one or more of a de-selection of the datasum application 108; an instruction to export the running sum total to the first application (e.g., 104, 122, 124); an instruction to export the running rum total to a second application (e.g., 118); or an instruction to export the running rum total to an application programming interface (e.g., 150).

The datasum application 108 enables an output presentation on the display of the most recent running sum total value. In an embodiment, the output presentation includes a hovering bubble, as shown in FIG. 3 (e.g., 318) and FIG. 5 (e.g., 534). The hovering bubble is configured as a geometric shape that encloses the running sum total. Other presentation outputs, besides a hovering bubble, are also included within the scope of the present disclosure. For example, datasum application 108 includes a configuration module (not shown), wherein the user configures the presentation output the running sum total value is to have. The configuration module also includes other setting functionality, such as a setting that specifies how the user would like to start and stop the datasum application 108. As described herein, two example embodiments of how the user starts sand stops the datasum application is shown by example visual interfaces of FIG. 3 and FIG. 5.

FIG. 2 illustrates a flowchart of a method 200 for providing a running sum total of user-selected data in accordance with some embodiments. FIG. 3 is a schematic of a sequence of visual interface instances 302, 304, 306, 308, and 310 displaying data and images in accordance with some embodiments. The visual interfaces illustrate a presentation of the visual data and images that are produced when the electronic device 100 performs the method 200 for providing a running sum total of user-selected data. FIGS. 2 and 3 are described concurrently to enhance clarity.

In accordance with method 200, a data presentation application provides (202) visual data to a user. This may be done by displaying data from the presentation application (e.g., short messaging application 104) or in other words a “first application” on the display screen 102. The visual data includes numeric values 106. The data presentation application 104 provides (204) the user with access to the datasum application by presenting the user with a start/stop datasum button (110 in FIG. 1 or 312 in FIG. 3), which is an indication of a datasum application 108 for user selection.

As illustrated in FIG. 3, visual interface instance 302 shows how a display 102 presents a short messaging application 104 (as the type of data presentation application). The short messaging application 104 provides (204) the user with an indication of the datasum application, such as a datasum start/stop button 312. In another embodiment, the datasum application 108 provides the start/stop button 312. The short messaging application 104 provides (202) visual data, such as one or more individual messages, such as messages 314, 341, 342. In an embodiment, the short messaging application 104 presents the individual messages 314, 341, and 342 as a chain of multiple short messages on the display 102. In this example, the chain of multiple short messages is sent from a single originator entity, e.g., the user's bank (China Merchants Bank). Thus, the data of the short messaging application 104 is included within a chain of multiple short messages displayed on the display screen as associated with a single originating entity. Alternatively, the chain of multiple short messages displayed on the display 102 includes short messages that originate from a plurality of different originator entities. However, to keep the examples simpler for less confusion, embodiments described herein use one originating entity (e.g. China Merchants Bank) to issue the chain of multiple short messages (314, 341, 342, etc).

Returning again to method 200 of FIG. 2, the datasum application 108 checks (206) if the user has selected to initiate the datasum application 108. If the user has not initiated the datasum application, the device 100 operates as usual, for example, by continuing to provide visual data to the user, at 202. In one embodiment, when the user initiates the datasum application, such initiation is visually indicated to the user. For example, when the user initially selects the start/stop datasum application button (e.g., 110, 312) the datasum application 108 highlights the datasum application button 110, 312 to indicate that the datasum application has been initiated. Instances 304-311 of FIG. 3 show the datasum button 312 as being toggled on. More particularly, by highlighting the button 312 from the rest of the presentation, the datasum application 108 indicates that the datasum button 312 is toggled on. Surrounding the button area in a color is one method of highlighting the button 312. Other highlighting techniques, such as making the button larger with respect to the other display icons, etc., may be implemented as well.

Once initiated, the datasum application 108 begins by checking (208) whether the user has selected any input. If within a certain time, the user has not selected any input, the datasum application checks (210) whether the user has de-selected the datasum application. If the user has not de-selected the datasum application, the datasum application 108 will go back to checking (208) whether the user has selected any input. If the user has de-selected the datasum application, the datasum application provides (212) the user with an option to export the running sum total value to another application or an API. As long as the user is selecting more input, the datasum application 108 maintains the running sum total of the input to the datasum application 108. The running sum total is maintained until the user de-selects or resets the datasum application.

In another embodiment, the check (210) whether the user has de-selected the datasum application is replaced by the datasum application 108 treating a lack of user input selection, within a specified time, during the input check (208) as a de-selection of the datasum application 108. This also results in the datasum application 108 providing (212) the user with an option to export the running sum total value to another application or an API. Examples of other applications to which the value may be exported include an email application, an accounting application, etc.

When the user selects (208) input, the datasum application 108 receives at least one numeric value selected by a user from the data as input to the datasum application 108. The datasum application 108 reads (214) the user-selected data as input into the adder module 114 of the datasum application 108. Instance 306 shows how a selection and presentation of a highlighted numeric value 106 is processed. For example, the user highlights the particular numeric value 316 (e.g., 323.00) of the message string “Your credit card with the last 4 digits XXXX was charged RMB 323.00 yuan at 20:xx xx December. You can get 3% cash back via joining the extraordinary Hong Kong and Macau tour. Reply DE for more details [China Merchants Bank]”.

The datasum application 108 determines (216) the running sum total by providing the user-selected data (numeric value 316, here 323.00) as input to the adder module 114 and by storing the running sum total in the data buffer 112. The adder module 114 adds any more input with the last stored running sum total value that was stored in the data buffer 112. The new running sum total value is stored in the data buffer 112. The adder module 114 determines an updated running sum total value when the user selects new input. In this case, because the 323.00 numeric value is the first input the user has made, the running sum total is equal to the first numeric value 316 (e.g., 323.00). The datasum application 108 stores the current running sum total value in the data buffer 112. The current running sum total value is provided to the consume data module 116. The consume data module 116 presents (218) the current running total value to the user on the display 102, as shown in instance 306 with a presentation icon, such as a first hovering bubble 318.

Any presentation icon, which is configured by the datasum application 108, or which was configured by the user via a configuration tool (not shown), is covered by the embodiments herein. As mentioned above, in the instance 306 the presentation icon that displays the running total value as an output is a hovering bubble 318. The hovering bubble 318 is displayed in a vicinity of the last numeric value 316 selected by the user from the data. Other presentation methods and icons are included in the present teachings, such as the hovering bubble 318 being a more general output icon that is configurable to have another geometric shape, or color, or three-dimensional (3D) effect, etc. The location of the presentation icon is configurable to be located anywhere on the display 102.

Instance 308 shows what happens when the user selects a new input of a second numeric value 320 (e.g., 205.00) of the message string “Your credit card with the last 4 digits XXXX was charged RMB 205.00 yuan at 20:xx xx January. [China Merchants Bank]” as input to the datasum application's 108 adder module 114. When the user selects the second numeric value 320 as input, datasum application 108 reads (214) the user-selected data as input into the adder module 114 and updates (216) the running sum total value by adding the new input value to the running sum total value that was stored in the data buffer 112 (e.g., 323.00+205.00=528). The adder module updates the data buffer 112 with the latest running sum total value (e.g., 528.00). The datasum application 108 sends the latest running sum total value to the consume data module 116. The consume data module 116 presents (218) the latest running sum total value in a presentation icon, such as the hovering bubble 318, which presents the latest running sum total value 324 (e.g., 528.00) to the user.

Instance 310 repeats the process shown in instance 308 by applying (214) a third input to the datasum application. The third numeric input is a numeric value 326 (590.00) of the message string “Your credit card with the last 4 digits XXXX was charged RMB 590.00 yuan at 20:xx xx January. [China Merchants Bank]”. Accordingly, the datasum application 108 updates (216) the last running sum total with the new input (e.g., 528.00+590.0=1118.00), to produce (218) the hovering bubble 318 with the latest running sum total 330 (e.g., 1118).

As the user selects inputs, such as the first, second, and third numeric values, which are, respectively, 323.00, 205.00, and 590.00 as shown, the datasum application reads (214) each input; determines (216) the updated running sum total values, respectively 323.00, 528.00, and 1118.00; and presents (218) each updated running sum total value to the user. In one embodiment, after the user is done selecting numeric values as inputs, the user de-selects the start/stop button 312. The datasum application 108 checks (210) for a de-selection. If true, the datasum application 108 un-highlights the datasum button 312, in this example implementation. Moreover, in a further embodiment, the datasum application 108 provides (212) the user with export options for the user to export the final running sum total value to another application, e.g., 118, an API, etc.

In another example, the datasum application 108 provides (212) the user with more options that are, for instance, presented in a pop-up menu 332. Such options include, by way of example, any one or more of the following functions: convert currency, email, text, reset, export, etc. In an embodiment, if the user selects the export option, the datasum application 108 presents a second pop-up window 334 with export options. Alternatively, the datasum application 108 processes a click on the datasum button 312 by the user as an export instruction for the running sum total. In either case, the export instruction can comprise at least one of: exporting the running sum total to the first application; exporting the running sum total to a second application; or exporting the running sum total to an application programming interface.

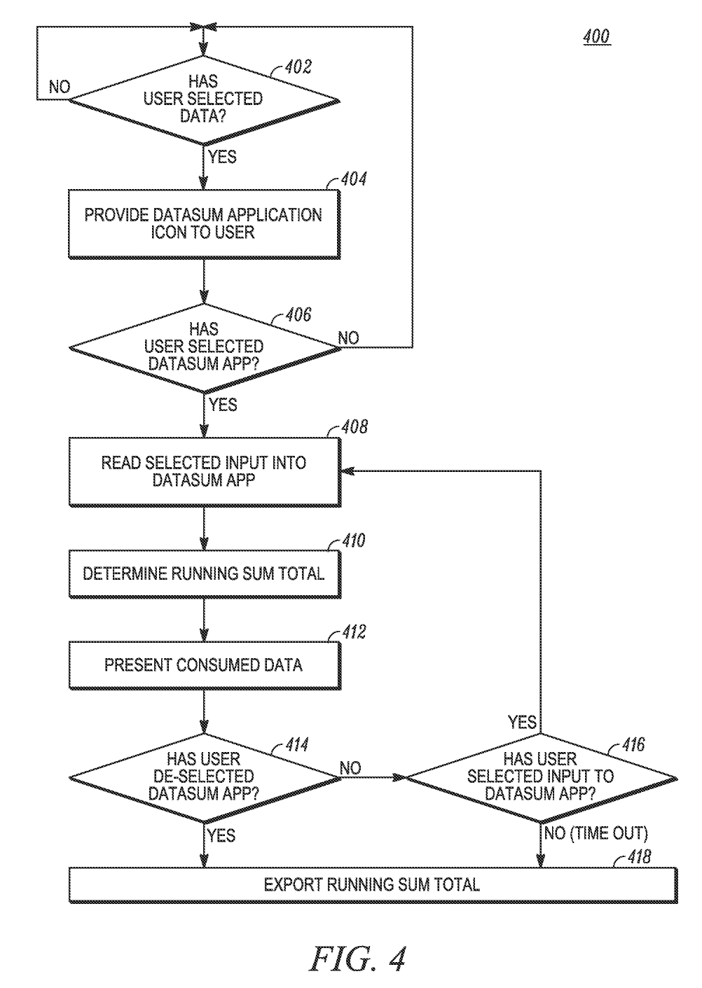

FIG. 4 is another flowchart of a method 400 for providing a running sum total of user-selected data in accordance with some embodiments. FIG. 5 is a schematic of a sequence of visual interface instances 502, 504, 506, 508, 510, 512, 514, and 516 displaying data and images in accordance with some embodiments. The visual interface instances illustrate a presentation of the visual data and images that are produced when the electronic device 100 performs the method 400 for providing a running sum total of user-selected data. FIGS. 4 and 5 are described concurrently to enhance clarity.

In accordance with method 400, a data presentation application (e.g., 104) provides visual data to a user. Datasum application 108 checks (402) whether the user has selected data from the data presentation application 104. Visual interface instance 502 shows a display 102 presenting a short messaging application 104 (as the type of data presentation application) including a chain of short messages, 512, 514, 516, and 518. Similar to the embodiment in FIG. 3, the chain of multiple short messages displayed on the display 102 may include short messages that originate from a single originator entity or from a plurality of different originator entities. In this case, messages 512, 514, 516, 518 originate from different originator entities (e.g., Starbucks, Dr. Sturgill, AT&T, and Mobil gas) but are all displayed by messaging application 104.

Instance 504 of FIG. 5 shows a user making a selection by highlighting the numeric value $5.00 (520) of message 512 “Starbucks $5.00” with the selection pointer (522). Numeric value $5.00 (520) is the user-selected data. When user-selected data is detected (402), the datasum application 108 provides (404) a datasum application icon or other indication for the user to select in order to initiate the datasum application 108 functionality. The datasum application icon may be a pop-up button or other type of icon that alerts the user to the availability of the datasum application 108. In one example implementation, the processor and the visual interface are configured to provide the datasum application icon in response to the user selecting a first numeric value from the data, as shown in 504. Moreover, instance 506 shows the indication of the datasum application as a datasum application start pop-up button 528, which may be a part of a larger menu 526 of options for the user to perform other functionality, such as “copy” 530, etc. As shown and in accordance with one embodiment, the indication of the datasum application is located on the display screen near the selected first numeric value.

Turning again to the method 400, the datasum application 108 checks (406) if the user has selected to run the datasum application 108. If the user does not initiate the datasum application, the device 100 operates as usual, for example, by continuing to provide visual data to the user and continuing to check (402) for user-selected data. If the user does initiate the datasum application by selecting (406) the datasum application icon, the datasum application reads (408) the user-selected data by inputting the data into the adder module 114. The adder module 114 determines (410) the running sum total of the user-selected data. The adder module 114 stores the running sum total in a data buffer 112, which is presented to the consume data module 116. The consume data module 116 presents (412) the running sum total value 536 (e.g., $5.00) to the user on the display screen 102 via a presentation output, such as a hovering bubble 534. As described above, the datasum application 108 can include a configuration module (not shown), wherein the user configures how the running sum total value is presented. In some embodiments, the running sum total value is presented in a hovering bubble 534 that is displayed in a vicinity of a last numeric value selected by the user from the data, as illustratively shown in instance 508.

Instance 510 shows the user selecting a second input numeric value, $275.00, by highlighting this numeric value using an arrow, for instance. The datasum application 108 determines (410) the updated running sum total by processing the second input to produce an updated running sum total 538 (e.g., $280.00), which is presented (412) to the user by the consume data module 116. For example, each time a new input is processed, the consume data module 116 presents (412) the hovering bubble 534 in a new location that is located on the display near the last selected input.

Instance 512 shows the user selecting a third input $110.00, which is processed through the datasum application 108 to determine (410) an updated running sum total value 540 (e.g. $390.00). Each updated running sum total is presented (412), by the consume data module 116, in the hovering bubble 534 at the newest location. Instance 514 shows the user selecting a fourth input $72.00, which is processed through the datasum application 108 to determine (410) an updated running sum total value 542 (e.g. $462.00) that is presented (412) in the hovering bubble 534.

Each time the running sum total is presented to the user, the datasum application 108 checks (414) whether the user has de-selected the datasum application 108. Instance 516 shows the user de-selecting the datasum application 108 by clicking or selecting the hovering bubble 534 or its contents, for instance using an arrow. In an embodiment, the datasum application 108 processes a selection of the hovering bubble 534 or selection of the contents of the hovering bubble 534 as a de-selection of the datasum application 108. In a further embodiment, when the user de-selects the datasum application, the datasum application 108 presents (418) export options by presenting an export pop-up menu 544.

In one example implementation, the export pop-up menu 544 includes options such as sending the running sum total to other applications or APIs for performing any one or more of the following functions: convert currency, email, text, reset, export, etc. These options are made available via a button or other icon type input, which the user may select. Alternatively, the datasum application 108 processes a selection of the hovering bubble 534 or its contents as an export instruction (418) of the running sum total to a second application. Alternatively, the datasum application 108 processes a selection of the hovering bubble 534 or contents of the hovering bubble 534 as an export instruction of the running sum total, wherein the export instruction comprises at least one of: exporting the running rum total to the first application; exporting the running sum total to a second application; or exporting the running sum total to an application programming interface.

If the user has not de-selected the datasum application 108, the datasum application 108 keeps checking (416) for user-selected-input. If the user selects additional input values, the datasum application 108 repeats the functionality in blocks 408, 410, 412, 414, until the user either de-selects (414) the datasum application 108 or the datasum application 108 has not received any more input and has timed out (416).

In another embodiment, the datasum application 108 initiation is invisible to the user 152. For example, the datasum application 108 is initiated automatically upon initiation of the first application, such as any data presentation application (e.g., the short messaging application 104, the email application 122, or the document viewer application 124). Moreover, in this embodiment, the datasum application 108 is automatically de-selected when the user exits the particular data presentation application. In this case, upon exiting the data presentation application, the datasum application 108 exports the latest running sum total value and zeroes out the adder 114, the data buffer 112, and the consume data module 116. The particular export procedure that is used by the datasum application 108 upon exit (e.g., exporting the final running sum total to a different application or into memory 130 to use at another time) is automatic upon exit of the particular data presentation application or is preconfigured by the user 152.

Similar to the above-described embodiments, during operation of the datasum application 108, the user selects the data for input to the datasum application 108 by highlighting a numeric value 106 from the presented data. The highlighted numeric value is input to the datasum application 108 to produce the running sum total value, which is presented to the user 152 in a hovering bubble (e.g., 318, 534) on the display screen 102. When a next numeric value 106 is highlighted, that next numeric value is input to the datasum application 108 to produce an updated running sum total value. The updated running sum total value is displayed to the user via the hovering bubble (e.g., 318, 534). To reset the running sum total value, the user 152 clicks or selects the hovering bubble (e.g., 318, 534) or its contents. The user 152 may then provide new input to the datasum application 108.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for providing a running sum total of user-selected data, performed in an electronic device having a display screen, the method comprising:
displaying data from a first application on the display screen, wherein the data comprises numeric values;
displaying an indication of a datasum application, on the display screen, for selection by a user;
receiving at least one numeric value selected by the user from the data as input to the datasum application;
displaying a running sum total of the input to the datasum application on the display screen.

2. The method of claim 1 further comprising maintaining the running sum total of the input to the datasum application until the datasum application is reset.

3. The method of claim 1, wherein the first application is one of a short messaging application, an email application, or a document viewer application.

4. The method of claim 3, wherein the first application is the short messaging application, and the data is included within a chain of multiple short messages displayed on the display screen as associated with a single originating entity.

5. The method of claim 1, wherein the running sum total is displayed in a hovering bubble.

6. The method of claim 5, wherein the hovering bubble is displayed in a vicinity of a last numeric value selected by the user from the data.

7. The method of claim 5 further comprising processing a selection of the hovering bubble or contents of the hovering bubble as a de-selection of the datasum application.

8. The method of claim 5 further comprising processing a selection of the hovering bubble or contents of the hovering bubble as an export instruction of the running sum total to a second application.

9. The method of claim 1 further comprising exporting the running sum total to a different application than the datasum application.

10. The method of claim 1 further comprising exporting the running sum total to an application programming interface.

11. The method of claim 1, wherein the indication of the datasum application is displayed on the display screen in response to the user selecting a first numeric value from the data.

12. The method of claim 11, wherein the indication of the datasum application is located on the display screen near the selected first numeric value.

13. An electronic device for providing a running sum total of user-selected data, the electronic device comprising:
a processor;
memory coupled to the processor, wherein the memory is configured to store a first application and a datasum application;
a visual interface coupled to the processor, wherein the visual interface is configured to display data from the first application, wherein the data includes numeric values;
a user input device coupled to the processor, wherein the user input device is configured to receive an input at least one numeric value selected by a user from the data and to provide the at least one selected numeric value as input to the datasum application;
wherein the processor is configured to provide a running sum total, of the input to the datasum application, to the visual interface for presentation to the user.

14. The electronic device of claim 13, wherein the visual interface and the user input comprise a touch screen display.

15. The electronic device of claim 13, wherein the electronic device is a portable wireless communication device.

16. The electronic device of claim 13, wherein the datasum application includes a consume data module configured to export the running sum total to at least one of the first application, a second application, or an application programming interface.

17. The electronic device of claim 13, wherein the processor and the visual interface are configured to display an indication of the datasum application for user selection to initiate calculation of the running sum total.

18. The electronic device of claim 17, wherein the processor and the visual interface are configured to provide a datasum application icon in response to the user selecting a first numeric value from the data.

19. The electronic device of claim 13, wherein the processor and the visual interface are configured to present the running sum total in a hovering bubble configured as a geometric shape that encloses the running sum total.

20. The electronic device of claim 19, wherein the processor is further configured to process one or more clicks on the hovering bubble by the user as one or more of:
a de-selection of the datasum application;
an instruction to export the running rum total to the first application;
an instruction to export the running rum total to a second application; or
an instruction to export the running rum total to an application programming interface.
